(19) United States
(12) Patent Application Publication
(10) Pub. No.: US 2024/0129301 A1
(43) Pub. Date: Apr. 18, 2024

(54) VEHICLE NETWORK SECURITY

(71) Applicant: Ford Global Technologies, LLC, Dearborn, MI (US)

(72) Inventors: Yangho Kim, Northville, MI (US); Rajesh Balaji Vijayan, Novi, MI (US)

(73) Assignee: Ford Global Technologies, LLC, Dearborn, MI (US)

(21) Appl. No.: 18/046,163

(22) Filed: Oct. 13, 2022

(51) Int. Cl. H04L 9/40

(52) U.S. Cl. CPC H04L 63/0853; H04L 63/101

(57) ABSTRACT

A gateway device or the like in a vehicle can receive a packet from a device, such as an electronic control unit in the vehicle, via a port to a vehicle network. Upon determining that the device is defined on the vehicle network and not authenticated to the vehicle network, it can be determined whether the packet is an authentication packet. Upon determining that the packet is an authentication packet, it can be attempted to authenticate the device until authentication is successful or a threshold number of attempts is exceeded. Upon determining that the threshold number of attempts is exceeded, the port can be disabled.

### BACKGROUND

Modern vehicles typically include multiple electronic devices. For example, vehicles typically include multiple computing devices such as electronic control units (ECUs) or the like. The computing devices may communicate with one another and/or with other vehicle devices, e.g., vehicle sensors, via one or more vehicle communication networks. For example, ECUs in a vehicle may communicate via a controller area network (CAN) bus and/or an ethernet network. Further, some computing devices in a vehicle may communicate via an in-vehicle network such as one of the foregoing, as well as via a wide area network to communicate with remote or “cloud” servers.

### BRIEF DESCRIPTION OF THE DRAWINGS

FIG. 1 is a block diagram of a vehicle network security system.

FIG. 2 is a block diagram illustrating vehicle ECUs and a gateway on a vehicle network.

FIGS. 3A-3C show a process flow diagram illustrating an example process for validating ECUs on a vehicle network.

### DETAILED DESCRIPTION

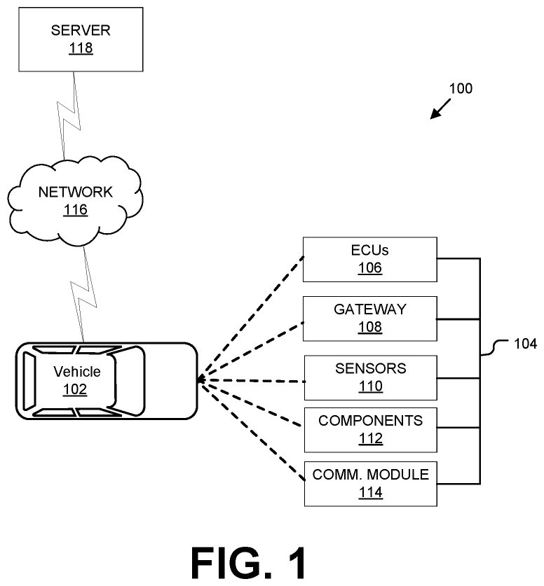

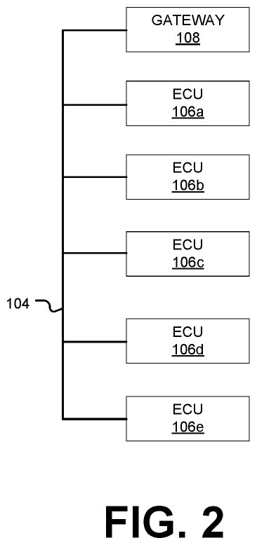

Referring to FIGS. 1 and 2, in an exemplary implementation, a plurality of ECUs 106 and a gateway device 108 can be connected to a vehicle network 104 in a vehicle 102. The gateway device 108 can allow the ECUs 106 to communicate with devices and/or networks external to the vehicle 102. For example, respective access ports can be specified for ECUs 106 to access the network 104. As described herein, the gateway device 108 can monitor and control communications by ECUs 106 on the network 104, thereby improving operation, including security, of the network 104.

An exemplary implementation comprises a system, comprising a gateway device connectable to a vehicle network and including a processor and a memory, wherein the processor is programmed to receive a packet from a device via a port to the vehicle network; upon determining that the device is defined on the vehicle network and not authenticated to the vehicle network, determine whether the packet is an authentication packet; upon determining that the packet is an authentication packet, attempt to authenticate the device until authentication is successful or a threshold number of attempts is exceeded; and upon determining that the threshold number of attempts is exceeded, disable the port.

The gateway device can be further programmed to block the packet upon determining that the device is not identified in an access control list as being allowed to access the port.

The gateway device can be further programmed to pass the packet after determining that a CPU utilization threshold associated with the port is not exceeded. The gateway device can be further programmed to disable the port after determining that a CPU utilization threshold associated with the port is exceeded. The CPU utilization threshold can specify a number of packets sent by the device to the port within a specified time. The gateway device can be further programmed to, upon determining that authentication is successful, pass the packet. The gateway device can be further programmed to block the packet upon determining that the device is not defined on the vehicle network. The gateway device can be connectable to a wide area network outside the vehicle.

An exemplary method comprises receiving a packet from a device via a port to a vehicle network in a vehicle; upon determining that the device is defined on the vehicle network and not authenticated to the vehicle network, determining whether the packet is an authentication packet; upon determining that the packet is an authentication packet, attempting to authenticate the device until authentication is successful or a threshold number of attempts is exceeded; and upon determining that the threshold number of attempts is exceeded, disabling the port.

The method can further comprise blocking the packet upon determining that the device is not identified in an access control list as being allowed to access the port. The method can further comprise one of (a) passing the packet after determining that a CPU utilization threshold associated with the port is not exceeded, or (b) disabling the port after determining that the CPU utilization threshold associated with the port is exceeded. The CPU utilization threshold can specify a number of packets sent by the device to the port within a specified time. The method can further comprise, upon determining that authentication is successful, passing the packet. The method can further comprise blocking the packet upon determining that the device is not defined on the vehicle network. The method can further comprise sending the packet via a wide area network outside the vehicle.

The vehicle network can be an ethernet network. The device can be an electronic control unit (ECU). The threshold number of attempts can be three.

FIG. 1 is a block diagram of a vehicle network security system 100. A vehicle 102 in the context of this disclosure may be any suitable vehicle, e.g., a passenger or commercial automobile such as a sedan, a coupe, a truck, a sport utility, a crossover, a van, a minivan, a taxi, a bus, etc. Further, although this disclosure describes ground vehicles 102, the systems and methods could likewise be implemented with respect to water or air vehicles 102.

A vehicle 102 includes a vehicle network 104, i.e., a digital or packet network via which messages may be exchanged between various devices in vehicle 102, such as the gateway device 108 and/or ECUs 106, sensors 110, actuators, components 112, a communications module, etc. In cases in which computing device such as the gateway device 108 or an ECU 106 actually comprises a plurality of devices, the vehicle network 104 could be used for communications between such devices.

In example implementations, a vehicle network 104 can include an ethernet network and a controller area network (CAN) in which messages are conveyed via a CAN bus, and/or a local interconnect network (LIN) in which messages are conveyed via a LIN bus. For example, the gateway device 108 could be a gateway device 108 managing messages between a remote server 118 and devices in the vehicle 102 such as ECUs 106 communicating via a CAN bus and/or Ethernet. Yet further, in some implementations, the vehicle network 104 could include a network in which messages are conveyed using other wired communication technologies and/or wireless communication technologies e.g., WiFi®, Bluetooth®, etc. Additional examples of protocols that may be used for communications over vehicle network 104 in some implementations include, without limitation, Media Oriented System Transport MOST, Time-Triggered Protocol TTP, and FlexRay.

Accordingly, vehicle network 104 could represent a combination of multiple networks, possibly of different types, that support communications among devices in vehicle 102. For example, vehicle network 104 can include a CAN bus in which some devices in vehicle 102 communicate via a CAN bus, and a wired or wireless local area network in which some devices in vehicle 102 communicate according to Ethernet or Wi-Fi communication protocols, In the context of the network 104 different networking protocols are not mutually exclusive; some devices could communicate according to both CAN and ethernet, for example.

The ECUs 106 and the gateway device 108 are respective computing devices, which each typically include respective processors and memories. A memory includes one or more forms of computer readable media, and stores instructions executable by the respective computing device for performing various operations, including as disclosed herein. For example, a computing device can be a generic computer with a processor and memory as described above and/or may include an ECU 106 or gateway device 108 for a specific function or set of functions, and/or a dedicated electronic circuit including an ASIC (application specific integrated circuit) that is manufactured for a particular operation, e.g., an ASIC for processing sensor 110 data and/or communicating the sensor 110 data. In another example, a vehicle 102 computer may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g. stored in a memory electrically connected to the FPGA circuit. In some examples, a combination of processor(s), ASIC(s), and/or FPGA circuits may be included in a computing device.

The memory of a computing device can be of any suitable type, e.g., hard disk drives, solid state drives, servers 118, or any volatile or non-volatile media. The memory can store program instructions, various data such as identifiers or the like as discussed further below, and/or collected data sent from vehicle sensors 110. The memory can be a separate device from the computing device, and the computing device can retrieve information stored by the memory via a network in the vehicle 102, e.g., over a CAN bus, a wireless network, etc. Alternatively or additionally, the memory can be part of the computing device.

A computing device, e.g., an ECU 106, may include programming to operate one or more of vehicle 102 brakes, propulsion e.g., control of acceleration in the vehicle 102 by controlling one or more of an internal combustion engine, electric motor, hybrid engine, etc., steering, climate control, interior and/or exterior lights, etc., as well as to determine whether and when the computer, as opposed to a human operator, is to control such operations. Additionally, a computing device in the vehicle 102 may be programmed to determine whether and when a human operator is to control such operations.

The gateway device 108 allows devices on the vehicle network 104, such as ECUs 106, to communicate with devices external to the vehicle network 104, such a server 118 communicating with the vehicle 102 via the wide area network 116. As such, the gateway device 108 is a computing device as described above. The gateway can send messages to and from vehicle 102 devices such as the ECUs 106 via the vehicle network 104, and can actuate the communication module 114 to send messages to and from devices outside the vehicle 102 such as a server 118. In one example, the vehicle network 104 is or includes an ethernet network. Once ECUs 106 are authenticated to the ethernet network, the ECUs 106 can send and receive messages via the gateway device 108 which in turn, as just mentioned, can communicate with one or more remote servers 118 or the like via the wide area network 116.

A vehicle 102 typically includes a variety of sensors 110 that provide data on the vehicle network 104. A sensor 110 is a device that can obtain one or more measurements of one or more physical phenomena. Example vehicle 102 sensors 110 could include cameras, short range radar, long range radar, LIDAR, and/or ultrasonic transducers, weight sensors 110, accelerometers, motion detectors, etc., i.e., sensors 110 to provide a variety of data. To provide just a few non-limiting examples, sensor 110 data could include data for determining a position of a component 112, a location of an object, a speed of an object, a type of an object, a slope of a roadway, a temperature, a presence or amount of moisture, a fuel level, a data rate, etc.

ECUs 106 and the like may include programming to command one or more actuators to operate one or more vehicle 102 subsystems or components 112, such as vehicle 102 brakes, propulsion, or steering. That is, an ECU 106 may actuate control of acceleration in the vehicle 102 by controlling one or more of an internal combustion engine, electric motor, hybrid engine, etc., and/or may actuate control of brakes, steering, climate control, interior and/or exterior lights, etc.

As seen in FIG. 2, various ECUs 106 can be provided along with the gateway 108 on the vehicle network 104. Vehicle ECUs 106 can be provided to allow another computer to request various operations and/or data, such as telemetry data (e.g., location, speed, ignition status, diagnostic data, etc., of a vehicle 102), disabling or enabling a propulsion, notification that a vehicle 102 security system is breached, access to and control of a vehicle network 104 such as a Wi-Fi network, etc. ECUs 106 are collectively referred to herein as ECUs 106, but in FIG. 2 ECUs 106a-106e are separately labeled to illustrate different ones of various ECUs 106.

For communications outside the vehicle 102, e.g., via the wide area network 116 as mentioned above, the gateway device 108 (and possibly other vehicle 102 computing devices) may be configured for communicating via communication module 114 or interface with devices outside of the vehicle 102, e.g., through vehicle 102 to vehicle 102 (V2V), vehicle-to-infrastructure or everything (V2X), vehicle-to-everything including cellular communications (C-V2X), to another vehicle 102, to an infrastructure element, typically via direct radio frequency communications, and/or, typically via the wide area network 116, to one or more remote servers 118. The communication module 114 could include one or more mechanisms by which the computers of vehicles 102 may communicate, including any desired combination of wireless e.g., cellular, wireless, satellite, microwave and radio frequency communication mechanisms and any desired network topology or topologies when a plurality of communication mechanisms are utilized. Exemplary communications provided via the communication module 114, e.g., for communicating with a server 118, can include cellular, Bluetooth, IEEE 802.11, dedicated short range communications (DSRC), cellular V2X (CV2X), MQTT, gRPC, and the like.

The wide area network 116 can include one or more mechanisms by which the communication module 114 may communicate with, for example, a remote server 118. Accordingly, the wide area network 116 can include one or more of various wired or wireless communication mechanisms, including any desired combination of wired e.g., cable and fiber and/or wireless e.g., cellular, wireless, satellite, microwave, and radio frequency communication mechanisms and any desired network topology or topologies when multiple communication mechanisms are utilized. Exemplary communication networks include wireless communication networks e.g., using Bluetooth, Bluetooth Low Energy BLE, IEEE 802.11, V2V, V2X, CV2X, DSRC, local area networks LAN, and/or the Internet.

The remote server 118 is a computing device such as described above. Sometimes the remote server 118 may be referred to as a “cloud” server because it is remote from the vehicle 102 and accessed via the wide area network 116.

As noted above, the gateway device 108 is connectable to the vehicle network 104 to communicate with other devices such as ECUs 106 on the vehicle network 104.

Upon receiving a packet for packets from one or more ECUs 106, the gateway device 108 can retrieve respective identifiers of one or more electronic control units (ECU) from a memory. For example, the identifier of an ECU 106 could be an electronic serial number (ESN) or some other device identifier (DID), that identifies the ECU 106 on the vehicle network 104. ECUs 106 could identify themselves to the gateway on the vehicle network 104, e.g., in response to a network wake up and/or vehicle 102 ignition ON event. The gateway 108 could maintain a table or the like of ECUs 106 and respective identifiers. ECUs 106 can then be accessed via the vehicle network 104 according to their respective identifiers. These identifiers may be referred to as static identifiers because they typically are stored in read-only memory and do not change. ECUs 106 that are permitted access to the network 104 can be stored in the read-only memory in what may be referred to as an “access control list,” for example.

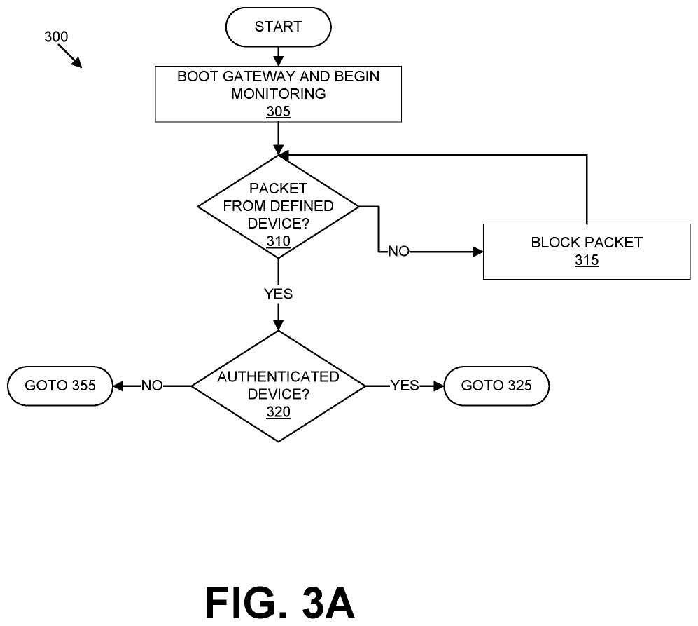

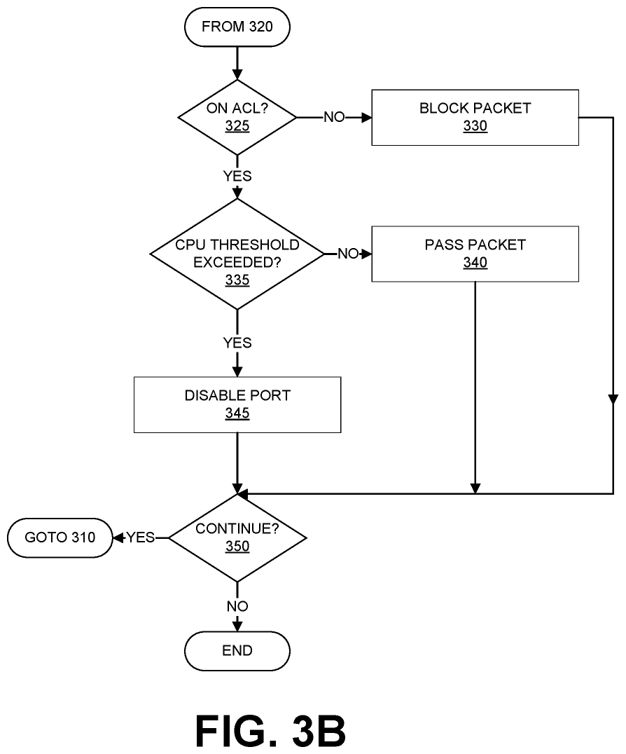

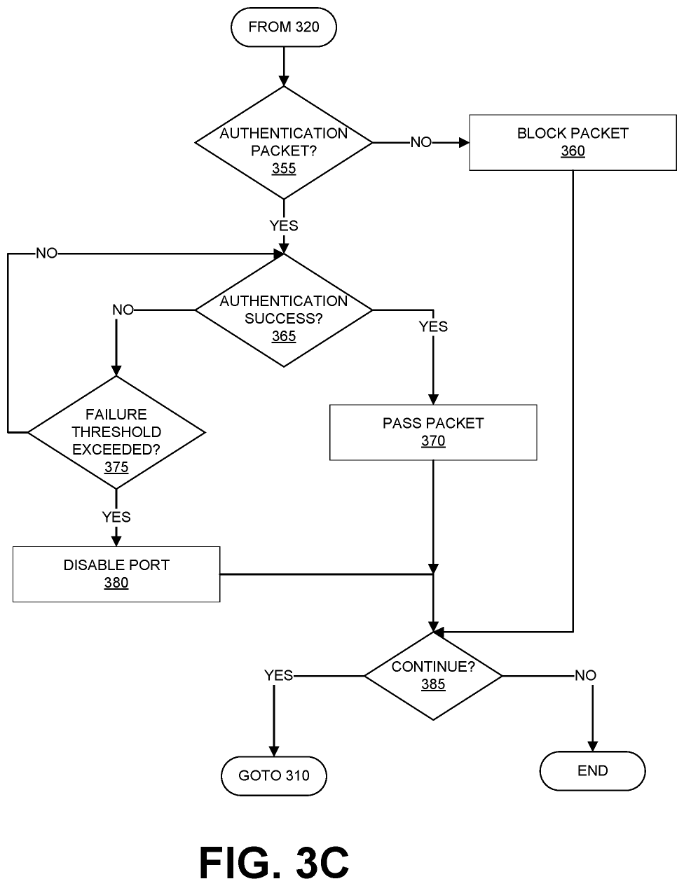

FIGS. 3A, 3B, and 3C collectively show a process flow diagram illustrating an example process 300 for validating ECUs on a vehicle network.

As illustrated in FIG. 3A, the process 300 can begin in a block 305, in which the gateway device 108 is booted. For example, the gateway device 108 may begin boot-up upon a vehicle ignition ON or other wake up or start up event or trigger. Upon boot-up, the gateway device 108 may load or retrieve, e.g., from a long-term or read-only memory, a list of devices, e.g., ECUs 106, permitted to access the network 104. The list of devices typically identifies the devices according to device identifiers (DIDs) or the like, and also includes an identifier or identifiers for a port or ports of the network 104 that the device, e.g., ECU 106, is permitted to utilize or access. The gateway 108 may then begin monitoring the network 104 to detect packets from devices such as ECUs 106.

Next, in a block 310, upon receiving or detecting a packet via the network 104, the gateway device 108 determines whether the packet is from a device defined for the network 104, e.g., according to the list of devices described above. As will be understood, a packet sent via a digital network via a device such as an ECU 106 will typically include a packet header identifying a packet sender, e.g., according to a DID or the like. Further, the packet may be received via and/or may be requesting access to a specific communication port on the network 104. Typically, where devices are ECUs 106 in a vehicle 102, the ECUs 106 are programmed or configured to receive a wake-up or start up signal via a vehicle controller area network (CAN), whereupon the ECU 106 may request access to the network 104 via the gateway 108. Further, once access is provided, e.g., as described further below, and ECU 106 may send packets to, and receive packets via, the gateway 108 as part of communications the of the wide area network 116. If the packet detected or received in the block 310 is not from an ECU defined for the network 104, then a block 315 is executed next. Otherwise, a block 320 is executed next.

In the block 315, the gateway device 108 blocks of the packet detected in the block 310. That is, the gateway device 108 prevents the packet from being transmitted over the network 104, e.g., to the communication module 114, to any ECUs 106, etc. The process 300 then returns to the block 310.

In the block 320, the gateway device 108 determines whether the packet received in the block 310 is from a device that has been authenticated to the network 104. The gateway device 108 may authenticate devices such as ECUs 106 to the network 104, and can maintain a list in memory of devices that have been authenticated. If the device has been authenticated, then the process 300 proceeds to a block 325. If the device has not been authenticated, then the process 300 proceeds to a block 355.

Turning now to FIG. 3B, in the block 325, which may follow the block 320, the gateway device 108 determines whether the device determined to be authenticated in the block 320 is on an access control list (ACL) or the like, and/or whether the access control list specifies that the device is permitted to use a network 104 port to which the device requests access. If the device is not on the access control list, including the device not being associated with a requesting port on the access control list, then a block 330 is executed next. Otherwise, a block 335 is executed next.

In the block 330, the gateway device 108 blocks of the detected packet, e.g., as described above with respect to the block 315.

In the block 335, the gateway device 108 determines whether a CPU utilization threshold of the gateway device 108 has been exceeded. In some examples, the CPU utilization threshold can be a threshold associated with the requested port, i.e., is determined by a number of packets in a specified time that the ECU 106 or other device is attempting to send and/or received via the requested port. This measurement is used because sending a number of packets over a threshold via a port can be an indication of malicious activity. For example, the threshold could specify that no more than 200 packets in one second may be sent via by the ECU 106. Alternatively or additionally, the CPU threshold could be an amount of volatile memory in the gateway device 108 being used to manage network 104 (e.g., ethernet) activity at the requesting port. If the CPU threshold is not exceeded, then a block 340 is executed next. Otherwise, the process 300 proceeds to a block 345.

In the block 340, the gateway device 108 passes the packet detected in the block 310. That is, the gateway device 108 allows the ECU 106 to access the port and thereby allows the packet to be sent and/or allows a packet to be received, via the requesting port. Following the block 340, the process 300 proceeds to a block 350.

In the block 345, the gateway device 108 disables the requested port. That is, the gateway device 108 prevents packets from being sent and/or received via the port. In implementations in which the ECU 106 uses a dedicated port, i.e., the requested work is the only port accessible to the ECU 106, all packets to and from the ECU 106 associated with the request are blocked.

In the block 350, which may follow either of the block 340, 345, the gateway device 108 determines whether the process 300 is to continue. For example, a vehicle ignition OFF signal may be received, whereupon the process 300 may be terminated. If the process 300 is to continue, then control may return to the block 310. Otherwise, the process 300 ends following the block 350.

Turning now to FIG. 3C, in a block 355, the gateway device 108 determines whether the packet received in the block 310 is an authentication packet. Recall that the block 355 is reached after a determination in the block 320 that a device sending the packet is not authenticated to the network 104. Accordingly, the gateway device 108 can determine whether the packet is part of an authentication process, e.g., according to a packet header and/or payload, whether the packet is an authentication packet. If the packet is not an authentication packet, then the process 300 proceeds to a block 360. Otherwise, the process 300 proceeds to a block 365.

In the block 360, the gateway device 108 blocks the packet, e.g., as described above with respect to the block 315. The process 300 then proceeds to a block 385.

In the block 365, the gateway device 108 determines whether the ECU 106 or other device transmitting a packet has been successfully authenticated to the network 104. Note that any suitable authentication technique may be used, e.g., involving an exchange of secure keys or the like. If the authentication was successful, and the process 300 proceeds to a block 370. Otherwise, the process 300 proceeds to a block 375.

In the block 370, the gateway device 108 passes the packet, e.g., as described above with respect to the block 340. The process 300 then proceeds to the block 385.

In the block 375, the gateway device determines whether an authentication failure threshold has been exceeded. That is, authentication having been determined not to be successful in the block 365, the gateway device 108 can determine a number of unsuccessful authentications, e.g., one or more. The authentication failure threshold can be set to be a number likely to indicate that an unauthorized or malicious attempt is being made to access the network 104. In one implementation, the authentication failure threshold is three failed authentication attempts. If the authentication failure threshold is not exceeded, then the process 300 can return to the block 365. Otherwise, the process 300 proceeds to the block 380.

In the block 380, the requested port is disabled, e.g., as described above with respect to the block 345. The process 300 then proceeds to the block 385.

In the block 385, the gateway 108 can determine whether to continue the process 300, e.g., as described above with respect to the block 350. The process 300 can either continue in the block 310, or can and following the block 385.

The computing devices discussed herein include processors and memories as stated above. The memories generally including instructions executable by one or more of the computing devices' processors, such as instructions disclosed in the foregoing, and instructions for carrying out blocks or steps of processes described above. Computer executable instructions may be compiled or interpreted from computer programs created using a variety of programming languages and/or technologies, including, without limitation, and either alone or in combination, Java™, C, C++, Visual Basic, Java Script, Python, Perl, HTML, etc. In general, a processor (e.g., a microprocessor) receives instructions, e.g., from a memory, a computer readable medium, etc., and executes these instructions, thereby causing one or more actions and/or processes to occur, including one or more of the processes described herein. Such instructions and other data may be stored and transmitted using a variety of computer readable media. A file in the computer is generally a collection of data stored on a computer readable medium, such as a storage medium, a random access memory, etc.

A computer readable medium includes any medium that participates in providing data (e.g., instructions), which may be read by a computer. Such a medium may take many forms, including, but not limited to, non volatile media, volatile media, etc. Non volatile media include, for example, optical or magnetic disks and other persistent memory. Volatile media include dynamic random access memory (DRAM), which typically constitutes a main memory. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of systems and/or processes herein are provided for the purpose of illustrating certain embodiments and should in no way be construed so as to limit the disclosed subject matter.

Accordingly, it is to be understood that the present disclosure, including the above description and the accompanying Figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise. The phrase “based on” encompasses being partly or entirely based on.

1. A system, comprising a gateway device connectable to a vehicle network and including a processor and a memory, wherein the processor is programmed to:
receive a packet from a device via a port to the vehicle network;
upon determining that the device is defined on the vehicle network and not authenticated to the vehicle network, determine whether the packet is an authentication packet;
upon determining that the packet is an authentication packet, attempt to authenticate the device until authentication is successful or a threshold number of attempts is exceeded; and
upon determining that the threshold number of attempts is exceeded, disable the port.

2. The system of claim 1, wherein the gateway device is further programmed to block the packet upon determining that the device is not identified in an access control list as being allowed to access the port.

3. The system of claim 1, wherein the gateway device is further programmed to pass the packet after determining that a CPU utilization threshold associated with the port is not exceeded.

4. The system of claim 1, wherein the gateway device is further programmed to disable the port after determining that a CPU utilization threshold associated with the port is exceeded.

5. The system of claim 4, wherein the CPU utilization threshold specifies a number of packets sent by the device to the port within a specified time.

6. The system of claim 1, wherein the gateway device is further programmed to, upon determining that authentication is successful, pass the packet.

7. The system of claim 1, wherein the vehicle network is an ethernet network.

8. The system of claim 1, wherein the device is an electronic control unit (ECU).

9. The system of claim 1, wherein the threshold number of attempts is three.

10. The system of claim 1, wherein the gateway device is further programmed to block the packet upon determining that the device is not defined on the vehicle network.

11. The system of claim 1, wherein the gateway device is connectable to a wide area network outside the vehicle.

12. A method, comprising:
receiving a packet from a device via a port to a vehicle network in a vehicle;
upon determining that the device is defined on the vehicle network and not authenticated to the vehicle network, determining whether the packet is an authentication packet;
upon determining that the packet is an authentication packet, attempting to authenticate the device until authentication is successful or a threshold number of attempts is exceeded; and
upon determining that the threshold number of attempts is exceeded, disabling the port.

13. The method of claim 12, further comprising blocking the packet upon determining that the device is not identified in an access control list as being allowed to access the port.

14. The method of claim 12, further comprising one of (a) passing the packet after determining that a CPU utilization threshold associated with the port is not exceeded, or (b) disabling the port after determining that the CPU utilization threshold associated with the port is exceeded.

15. The method of claim 14, wherein the CPU utilization threshold specifies a number of packets sent by the device to the port within a specified time.

16. The method of claim 12, further comprising, upon determining that authentication is successful, passing the packet.

17. The method of claim 12, wherein the vehicle network is an ethernet network.

18. The method of claim 12, wherein the device is an electronic control unit (ECU).

19. The method of claim 12, further comprising blocking the packet upon determining that the device is not defined on the vehicle network.

20. The method of claim 12, further comprising sending the packet via a wide area network outside the vehicle.
